(19) United States
(12) Patent Application Publication
(10) Pub. No.: US 2006/0280445 A1
(43) Pub. Date: Dec. 14, 2006

(54) Image reproducing apparatus

(75) Inventors: Yasuo Masaki, Osaka (JP); Masahiro Takeshita, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/435,368

(22) Filed: May 16, 2006

(30) Foreign Application Priority Data
May 16, 2005 (JP) P2005-142520

(51) Int. Cl. H04N 7/00

(52) U.S. Cl. 386/95

(57) ABSTRACT

In a control unit, in a case where a person authentication unit cannot detect a face image from an image picked up by a camera unit in a predetermined time or more, reproducing situation data including person specifying information stored in an internal memory at the time thereof, a recording-medium identifying code of an on-reproducing recording medium, and a reproducing position address at the time of inputting the personal information are stored in the reproducing situation storage unit. After that, if the person authentication unit detects again the face image form the image picked up by the camera unit and, as a result of the authentication, if it is determined based on features of the face image that the person is the same as the original person, the reproducing operation starts from the reproducing position address stored in the reproducing situation storage unit.

### BACKGROUND OF THE INVENTION

1. Field of the Invention

The present invention relates to a reproducing apparatus capable of reproducing image information recorded in an image medium (recording medium) such as DVDs, and more particularly, to an image reproducing apparatus capable of improving a flexible usability in a case of a viewer temporarily leaves a site during the image reproducing operation and improving the flexible usability in a case where the viewer misses the on-viewing image by combining a technique for detecting an absent or sleeping state of the viewer.

2. Description of the Related Art

Conventionally, in a case where an image such as a drama and a movie is reproduced by using, for example, a DVD player, if a viewer does not view a monitor screen in order to go to the restroom or perform other tasks, the on-viewing image is continuously reproduced as far as the reproducing apparatus is arranged to be paused. Therefore, in a case where a missing portion is intended to be viewed, the previously viewed scene is needed to be searched by performing rewind.

In addition, in a general family where several persons use one DVD player, after one of them makes a site of the DVD player in a stopped state and leave the site thereof, another member of the family may view the same image media loaded on the DVD player. In this case, when the returning member intends to view the portion following the previously on-viewing image, the member needs to perform rewind to search the scene which the member viewed at the time of leaving the site. Like this, in a case where several persons use one DVD player, if the reproducing control of the one DVD player can be performed according to the individual situation of the members, it is very convenient. However, conventionally, such a DVD player has not been provided.

In addition, in order for several persons to use the one DVD player, individual persons must be authenticated. However, conventionally, various method of performing control by using such a authentication technique have been provided in the fields of image apparatuses such as TV sets.

For example, an image apparatus disclosed in JP-A-9-34424 includes an awakeness detection unit provided to the TV set to detect an awakeness of the viewer. When the awakeness detection unit detects a dozing state of the viewer, the recording unit is operated, and the TV set is powered off. In the image apparatus, the awakeness detection unit illuminates UV light on a face of the viewer picked up by an image pickup apparatus to detect reflecting image of the retina of the viewer, so that the dozing state or the sleeping state can be determined.

In addition, an image apparatus disclosed in JP-A-2004-363800 includes a recording medium in which receiving signals including images and sounds of TV broadcast can be recorded, a gaze detection unit for detecting a gaze of a TV viewer, a gaze detection determination unit for determining whether or not the gaze of the TV viewer is detected in a predetermined determination time by the gaze detection unit during the TV watching, and a recording start unit for starting recording in the recording medium for the receiving signals if the gaze of the TV viewer is not detected in the predetermined determination time by the gaze detection unit.

### SUMMARY OF THE INVENTION

As described above, a technique of combining a conventional image apparatus or image processing apparatus to detect the dozing state of the viewer and power off or start recording information in the recoding medium according to the result of the detection has been already proposed.

On the other hand, a site where the image apparatus is disposed is a general living room. In the living room, several persons such a father, a mother, a sister, and a brother simultaneously or individually view the same image apparatus. Therefore, in order to implement functions disclosed in JP-A-9-34424 and JP-A-2004-363800, the persons need to be specified. However, in JP-A-9-34424 and JP-A-2004-363800, the specifying of the persons is not considered. Therefore, there is a problem in that a technique for suitably treating the individual persons, that is, a technique for managing individual viewings of the viewers who simultaneously or individually viewing the same program (a drama, a movie, or the like) is not considered.

In order to solve the aforementioned problems, the present invention provides an image reproducing apparatus capable of individually managing viewing of viewers for a program (a drama, a movie, or the like) recorded in a recording medium. More specifically, the present invention provides an image reproducing apparatus capable of improving a flexible usability in a case of a viewer temporarily leaves a site during the image reproducing operation and improving the flexible usability in a case where the viewer misses the on-viewing image by combining a technique for detecting an absent or sleeping state of the viewer.

According to an aspect of the present invention, there is provided an image reproducing apparatus including: a reproducing unit for reproducing information recorded in a recording medium; a personal information registering unit for registering personal information in advance; an input unit for performing inputting various information; and a reproducing control unit for controlling recording-medium reproducing operation of the reproducing unit, wherein the image reproducing apparatus further comprises a reproducing situation storage unit for storing reproducing situations of a single one viewer or a plurality of viewers. In addition, under the control of the reproducing control unit, during a recording-medium reproducing operation, when person specifying information is input from the input unit, recording situation data including recording-medium identifying information of on-reproducing recording medium, reproducing position information at the time of inputting of personal information, and the input person specifying information are stored in the reproducing situation storage unit. After that, when reproducing command information and person specifying information are input from the input unit, the input person specifying information and the person specifying information stored in the reproducing situation storage unit are compared with each other, and if both information are equal to each other, recording-medium identifying information of a loaded recording medium and the recording-medium identifying information stored corresponding to the person specifying information are compared with each other. In addition, if both recording-medium identifying information are equal to each other, the reproducing operation starts at a reproducing position stored corresponding to the person specifying information or at a slightly pervious position thereof.

Like this, in the image reproducing apparatus according to the invention, since reproducing information (information on where the reproducing is stopped or paused) of individual persons is stored in the reproducing situation storage unit, in a case where the same program is intended to be viewed at a position following the reproducing position, it is possible to start the reproducing operation with a simple manipulation by using the reproducing information of the individual persons stored in the reproducing situation storage unit. Accordingly, it is possible to reproduce and view the same program from the position following the reproducing position. In addition, in the image reproducing apparatus according to the invention, in a case where several persons simultaneously or individually view the same program or individual programs, it is possible to perform individual viewing management.

In the above aspect of the present invention, under the control of the reproducing control unit, during the recording-medium reproducing operation, when the reproducing stop information and person specifying information are input from the input unit, the recording-medium reproducing operation may be stopped or paused.

In addition, in the stop state of the reproducing operation, when manipulation information is input from the input unit, if a single reproducing situation data or a plurality of reproducing data are stored in the reproducing situation storage unit, the image reproducing apparatus may further include a display unit for displaying the reproducing situation data. Here, the display unit denotes a monitor of a TV set connected to the image reproducing apparatus.

In addition, a single reproducing situation data may be selected from the reproducing situation data displayed on the display unit by using the input unit, so that the reproducing control unit starts the reproducing operation based on the selected reproducing situation data. Like this, by performing a simple manipulation such as selection of the reproducing situation data displayed on the screen, the reproducing operation can directly start at the viewer's desired position.

According to another aspect of the present invention, there is provided an image reproducing apparatus including: a reproducing unit for reproducing information recorded in a recording medium; an image pickup unit for picking up an image of a viewer; a face image detecting unit for detecting a face image from the image of the viewer picked up by the image pickup unit; an authentication unit for authenticating a on-viewing person by comparing the face image of the viewer detected by the face image detecting unit with a face image of a previously-registered person; and a reproducing control unit for controlling recording-medium reproducing operation of the reproducing unit, wherein the image reproducing apparatus further comprises a reproducing situation storage unit for storing reproducing situations of a single one viewer or a plurality of viewers, and wherein, under the control of the reproducing control unit, during a recording-medium reproducing operation, if the face image cannot be detected by the face image detecting unit in a predetermined time or more, the reproducing situation data including previously detected face image information, reproducing position information at the time that the face image cannot be detected, and recording-medium identifying information of the on-reproducing recording medium are stored in the reproducing situation storage unit; if the face image is detected by the face image detecting unit, and as a result of the authentication of the authentication unit, if the person is the same as a person of the face image information stored in the reproducing situation storage unit, recording-medium identifying information of a loaded recording medium and the recording-medium identifying information stored corresponding to the face image information are compared with each other; and if both recording-medium identifying information are equal to each other, the reproducing operation starts at the reproducing position stored corresponding to the face image information or at a slightly pervious position thereof.

Like this, in the image reproducing apparatus according to the invention, since reproducing information (information on where the reproducing is stopped or paused) of individual persons is stored in the reproducing situation storage unit, in a case where the same program is intended to be viewed at a position following the reproducing position, it is possible to start the reproducing operation by using the reproducing information of the individual persons stored in the reproducing situation storage unit. In this case, since the face image detection unit and the authentication unit are provided, the specifying of the person can be automatically performed by using these units. Therefore, without individual manipulations by using an input unit, the viewer can view the same program at the position following the reproducing position. Namely, in the image reproducing apparatus according to the invention, in a case where several persons simultaneously or individually view the same program or individual programs, it is possible to automatically perform individual viewing management by using the authentication unit.

In the above aspect of the present invention, under the control of the control unit, during the recording-medium reproducing operation, if the face image cannot be detected by the face image detecting unit in a predetermined time or more, the reproducing operation may be stopped or paused at the time thereof. Accordingly, in a case where any one does not view the program, it is possible to prevent unnecessary reproducing operation from being continuously performed.

In addition, under the control of the control unit, if the time that the face image cannot be detected by the face image detecting unit is within a predetermined time or less, the reproducing operation may not be stopped or paused but continuously performed. Namely, in a case where the time of not detecting the face image is within a short time (a predetermined time), for example, 1 to 2 second, the viewer may be consider to direct to a sideward or backward direction at that time. For the reason, in such a case, the reproducing operation is not needed to be stopped.

In addition, under the control of the control unit, f the face image is detected by the face image detecting unit, and as a result of the authentication of the authentication unit, if the person is not the same as a person of the face image information stored in the reproducing situation storage unit, a state that the reproducing operation is stopped or paused is displayed on a display unit. Accordingly, it is possible to prevent other persons from performing inadvertent manipulations in advance.

According to another aspect of the present invention, there is provided an image reproducing apparatus including: a reproducing unit for reproducing information recorded in a recording medium; an image pickup unit for picking up an image of a viewer; a face image detecting unit for detecting a face image from the image of the viewer picked up by the image pickup unit; an authentication unit for authenticating a on-viewing person by comparing the face image of the viewer detected by the face image detecting unit with a face image of a previously-registered person; and a reproducing control unit for controlling recording-medium reproducing operation of the reproducing unit, wherein the image reproducing apparatus further comprises: a moving object determination unit for determining whether or not there is a moving object from the picked-up image of the viewer picked up by the image pickup unit; and a reproducing situation storage unit for storing reproducing situations of a single one viewer or a plurality of viewers, wherein under the control of the reproducing control unit, during the recording-medium reproducing operation, if the moving object determination unit determines that there is the moving object and if it is determined that the face image cannot be detected by the face image detecting unit, the reproducing situation data including previously detected face image information, reproducing position information at the time that the face image cannot be detected, and recording-medium identifying information of the on-reproducing recording medium are stored in the reproducing situation storage unit; and if the face image is detected by the face image detecting unit, and as a result of the authentication of the authentication unit, if the person is the same as a person of the face image information stored in the reproducing situation storage unit, the reproducing operation starts at the reproducing position stored corresponding to the face image information or at a slightly pervious position thereof.

According to the present invention, in a case where the viewer who is in front of the image reproducing apparatus has another task, the moving object determination unit determines that the viewer does not consistently gaze at the reproducing screen. In this case, the reproducing position information at the time thereof is recorded, and the face image is detected by the face image detection unit again. In addition, as a result of the authentication, if the person is the same as the original person, the reproducing operation returns to the stored reproducing position and starts therefrom. In addition, during the time that the viewer performs another task, the reproducing operation may be continuously performed. However, at the time that the viewer views the reproducing image again, the reproducing operations returns to the stored reproducing position and starts therefrom, so that the viewer can view from the scene before the time that the viewer performs another task.

In the above aspect of the present invention, under the control of the control unit, during the recording-medium reproducing operation, if the face image cannot be detected by the face image detecting unit in a predetermined time or more, the reproducing operation may be stopped or paused at the time thereof. Accordingly, in a case where any one does not view the program, it is possible to prevent unnecessary reproducing operation from being continuously performed.

In addition, under the control of the control unit, if the time that the face image cannot be detected by the face image detecting unit is within a predetermined time or less, the reproducing operation may not be stopped or paused but continuously performed. Namely, in a case where the time that the face image cannot be detected is within a short time (a predetermined time), for example, 1 to 2 second, the viewer may be consider to direct to a sideward or backward direction at that time. For the reason, in such a case, the reproducing operation is not needed to be stopped.

According to another aspect of the present invention, there is provided an image reproducing apparatus including: a reproducing unit for reproducing information recorded in a recording medium; an image pickup unit for picking up an image of a viewer; a face image detecting unit for detecting a face image from the image of the viewer picked up by the image pickup unit; an authentication unit for authenticating a on-viewing person by comparing the face image of the viewer detected by the face image detecting unit with a face image of a previously-registered person; and a reproducing control unit for controlling recording-medium reproducing operation of the reproducing unit, wherein the image reproducing apparatus further includes: an eye opened/closed state determination unit for determining opened and closed states of eyes from the face image detected by the face image detecting unit; and a reproducing situation storage unit for storing reproducing situations of a single one viewer or a plurality of viewers, wherein under the control of the reproducing control unit, during the recording-medium reproducing operation, if the eye opened/closed state determination unit determines that the eyes are closed in a predetermined time or more, the reproducing situation data including previously detected face image information, reproducing position information at the time of the eyes closed, and recording-medium identifying information of the on-reproducing recording medium are stored in the reproducing situation storage unit; and if the eye opened/closed state determination unit determines that the eyes are opened again and, as a result of the determination, if the person is the same as a person of the face image information stored in the reproducing situation storage unit, the reproducing operation starts at the reproducing position stored corresponding to the face image information or at a slightly pervious position thereof.

According to the present invention, in a case where the eyes are determined to be closed in a predetermined time or more, the reproducing position information at the time thereof is recorded, and if the eyes are opened and, as a result of the authentication, only if the person is determined to be the same as the original person, the reproducing operation returns to the stored reproducing position to start therefrom. In addition, during the time that the viewer is in a dozing state, the reproducing operation may be continuously performed. However, at the time that the viewer is awakened from the dozing state, the reproducing operations returns to the reproducing position just before the dozing time and starts therefrom, so that the viewer can view from the scene just before the dozing time.

In the above aspect of the present invention, under the control of the control unit, if the eyes are determined to be closed by the eye opened/closed state determination unit in a predetermined time or more, the reproducing operation is stopped or paused at the time thereof. Accordingly, in a case where any one does not view the program, it is possible to prevent unnecessary reproducing operation from being continuously performed.

In addition, under the control of the control unit, if the eyes are determined to be closed by the eye opened/closed state determination unit with a predetermined time or less, the reproducing operation is not stopped or paused but continuously performed. Namely, in a case where the eye closed state is within a short time (a predetermined time), for example, 1 to 2 second, the viewer is not consider to fall into sleep. For the reason, in such a case, the reproducing operation is not needed to be stopped.

In addition, the control of the reproducing control unit, during the recording-medium reproducing operation, if the eye opened/closed state determination unit determines that the eyes are closed in a predetermined time or more, the reproducing situation data including previously detected face image information, reproducing position information at the time of the eyes closed, and recording-medium identifying information of the on-reproducing recording medium may be stored in the reproducing situation storage unit; the reproducing operation may be continuously performed and a fade out operation starts; and after an arbitrary time elapses from the time that a sound output is in minimum, the reproducing operation may be stopped. Accordingly, since unnecessary reproducing operation can be ended, so that it is possible to reduce power consumption.

In addition, under the control of the control unit, when the apparatus is powered on, the on-viewing person may be authenticated by the authentication unit, and if the data of the person authenticated by the authentication unit are in the reproducing situation storage unit, the reproducing situation data of the viewer may be displayed on the display unit to notify the presence of the data to the viewer. Accordingly, the viewer can recognize that there is a previously on-viewing program (a drama, a movie, or the like)

In addition, after the viewing is ended, the reproducing situation data stored in the reproducing situation storage unit may be automatically erased. Namely, the viewer may set the erasing thereof in advance, so that, after the viewing is ended, the reproducing situation data may be automatically erased. Accordingly, it is possible to solve the problem in that unnecessary reproducing situation data are remained in the reproducing situation storage unit.

In addition, the viewer or a manager having a management authority may be allowed to arbitrarily erase the reproducing situation data stored in the reproducing situation storage unit. Accordingly, it is possible to prevent a third person excluding a manager from erasing the reproducing situation data of the program (a drama, a movie, or the like) of which viewing is not yet ended.

According to the image reproducing apparatus of the present invention, reproduction information by persons (that is, information indicating at which position the reproduction is stopped or paused is stored in the reproducing situation storage unit. Accordingly, when the viewer wants to reproduce and view the same program from the stopped or paused position later, it is possible to start the reproduction of the program with a simple operation by the use of the reproduction information by persons stored in the reproducing situation storage unit. Therefore, even when the viewer views the program another day, it is possible to reproduce and view the program from the stopped or paused position. That is, according to the image reproducing apparatus of the invention, it is possible to perform individual view management by viewers when a plurality of viewers simultaneously or individually views a program. In addition, according to the invention, since one piece of reproducing situation data is selected by the use of the input unit among the reproducing situation data displayed on the display unit and then the reproducing operation is started on the basis of the selected reproducing situation data, it is possible to start the reproducing operation at a position desired by the viewer at once with a simple operation of selecting one among the reproducing situation data displayed on the screen.

According to the image reproducing apparatus of the invention, when the moving object determination unit determines that a viewer is located in front of the image reproducing apparatus but does not always view the reproduced image because he does something, the reproducing position information at that time is stored and the face image is detected again by the face image detection unit. When it is determined as a result of authentication of the authentication unit that the detected face image corresponds to the initial person, the reproducing operation is restarted at the stored reproduction position. Briefly speaking, even when the reproducing operation is successively performed while the viewer does something, the reproducing operation is restarted from the stored reproduction position when the viewer views again the reproduced image. Accordingly, the viewer can view the program from the scene before he does something. According to the invention, when the face image detection unit cannot detect the face image for a predetermined time during the reproducing operation of the recording medium, the reproducing operation is stopped or paused at that time. Accordingly, such unnecessary reproduction can be suppressed that the reproducing operation is continuously performed even when no one view the reproduced image. In addition, according to the invention, when the face image is detected again by the face image detection unit and it is determined as a result of authentication of the authentication unit that the detected face image does not correspond to the face image information stored in the reproducing situation storage unit, the display unit is allowed to display that the reproducing operation is stopped or paused. Accordingly, it is possible to prevent in advance an unexpected operation by another person.

According to the image reproducing apparatus of the invention, when it is determined that the eyes are closed for a predetermined time, the reproducing position information at that time is stored. When it is determined that the eyes are opened again and the viewer corresponds to the same person as the initial person, the reproducing operation is restarted from the stored reproducing position. Accordingly, even when the reproducing operation is continuously performed while the viewer dozes, the reproducing operation is restarted from the reproduction position right before the doze at the time of the viewer's recovering from the doze. Accordingly, the viewer can view the scene right before the doze without any action. In addition, according to the invention, when the eye opened/closed state determination unit determines that the eyes are closed for a predetermined time, the reproducing operation is stopped or paused at that time. Accordingly, such unnecessary reproduction can be suppressed that the reproducing operation is continuously performed even when no one view the reproduced image. In addition, according to the invention, when the eye opened/closed state determination unit determines that the eyes are closed for a predetermined time during the recording-medium reproducing operation, the information on the face image detected at that time, the information on the reproducing position at the time of the eyes' being closed, and the information specific to the recording medium under reproduction are stored in the reproducing situation storage unit and the fade-out of sound is started while continuously performing the reproducing operation. Then, in a predetermined time after the sound output becomes the minimum, the reproducing operation is stopped. Accordingly, the unnecessary reproducing operation can be ended without hindering the sleep of the viewer and it is thus possible to save power consumption. In addition, according to the invention, since the information stored in the recording medium is automatically erased by the viewer after the viewer finishes the viewing, it is possible to efficiently use the limited memory capacity of the recording medium. In addition, according to the invention, since the information stored in the recording medium can be erased only by the viewer or a manager having a management authority, it is possible to prevent a third party other than the manager from erasing the non-viewed data (movie or drama). In addition, according to the invention, when the power source of the image reproducing apparatus is turned on, a viewer is authenticated by the authentication unit and when the viewer's data exist in the reproducing situation storage unit, the reproducing situation data of the viewer is displayed on the display unit to notify the viewer of the data. Accordingly, the viewer can confirm such a program (drama or movie) that the viewer views up to only an intermediate portion thereof.

### BRIEF DESCRIPTION OF THE DRAWINGS

These and other objects and advantages of this invention will become more fully apparent from the following detailed description taken with the accompanying drawings in which:

FIG. 1 is a functional block diagram showing a whole construction of an image reproducing apparatus 1A according to a first embodiment of the invention;

FIG. 2 is a flowchart showing processing operations of a first example where reproducing situation data is stored in a reproducing situation storage unit;

FIG. 3 is a flowchart showing processing operations of a second example where reproducing situation data is stored in a reproducing situation storage unit;

FIG. 4 is a view for explaining a data structure of a reproducing situation storage unit;

FIG. 5 is a flowchart showing reproducing processing operations of a third example;

FIG. 6 is a functional block diagram showing a whole construction of an image reproducing apparatus according to a second embodiment of the invention;

FIG. 7 is a flowchart showing reproducing processing operations according to a fourth example;

FIG. 8 is a flowchart showing the reproducing processing operations according to the fourth example;

FIG. 9 is a flowchart showing reproducing processing operations according to a fifth example;

FIG. 10 is a flowchart showing the reproducing processing operations according to the fifth example;

FIG. 11 is a flowchart showing reproducing processing operations according to a sixth example;

FIG. 12 is a flowchart showing the reproducing processing operations according to the sixth example;

FIG. 13 is a flowchart showing processing operations in a case where information recorded in a recording medium is erased; and

FIG. 14 is a flowchart showing processing operations in a case where a presence of on-viewing information is notified to a viewer at the time of power-on.

### DETAILED DESCRIPTION OF THE EMBODIMENTS

Now, embodiment of the present invention will be described with reference to the accompanying drawings.

### First Embodiment

FIG. 1 is a functional block diagram showing a whole construction of an image reproducing apparatus 1A according to a first embodiment of the invention. In the image reproducing apparatus 1A according to the first embodiment, a user performs a manipulation input for specifying persons by using a later-described remote controller, so that reproducing situations of persons can be individually managed.

The image reproducing apparatus 1A includes a reproducing unit 12 for reproducing a recording medium (image media) such as DVDs, and the reproducing unit 12 is connected to a later-described control unit 18. In addition, a reproduced sound output of the reproducing unit 12 is connected to a sound input port 15b of a TV monitor 15. A reproduced image output of the reproducing unit 12 is connected to an image input port 15a of the TV monitor 15 through an OSD (on-screen display) circuit 14.

Although not shown, the control unit 18 is constructed with a CPU, a ROM, a RAM, and the like to control the reproducing unit 11 and the OSD circuit 14. A reproducing situation storage unit 13 for storing reproducing situation data of a single one viewer or a plurality of viewers is connected to the control unit 18 in a bi-directional manner. EPROMs, EEPROMs, Flash memories, or the like may used for the reproducing situation storage unit 13.

In addition, a key input portion 21 for inputting various key manipulation signals to the control unit 18 is connected to the control unit 18, and a receiving unit 22 for receiving the key manipulation signals from a remote controller 23 is connected to the key input portion 21. Namely, the key input portion 21 is designed to input the key manipulation signals received through the receiving unit 22 from the remote controller 23 as well as manipulation signals of various keys (buttons) disposed on a front panel of a main body of the apparatus. In addition, a clock unit 28 for indicating a current time and a later-described timer circuit unit 29 for measuring various times are connected to the control unit 18.

In the control unit 18, during a recording-medium reproducing operation for the recording medium 11 performed by the reproducing unit 12, when person specifying information is input from the remote controller 23, recording situation data including recording-medium identifying code unique to the on-reproducing recording medium 11, reproducing position information (reproducing position address) at the time of inputting of personal information, and the input person specifying information are stored in the reproducing situation storage unit 13; when reproducing command information and person specifying information are input from the remote controller 23, the input person specifying information and the person specifying information stored in the reproducing situation storage unit 13 are compared with each other; if both information are equal to each other, recording-medium identifying code of a loaded recording medium 11 and the recording-medium identifying code stored corresponding to the person specifying information are compared with each other; and if both recording-medium identifying code are equal to each other, the reproducing operation starts at a reproducing position stored corresponding to the person specifying information or at a slightly pervious position thereof. Now, examples of various processing operations of the control unit 18 will be described.

### FIRST EXAMPLE

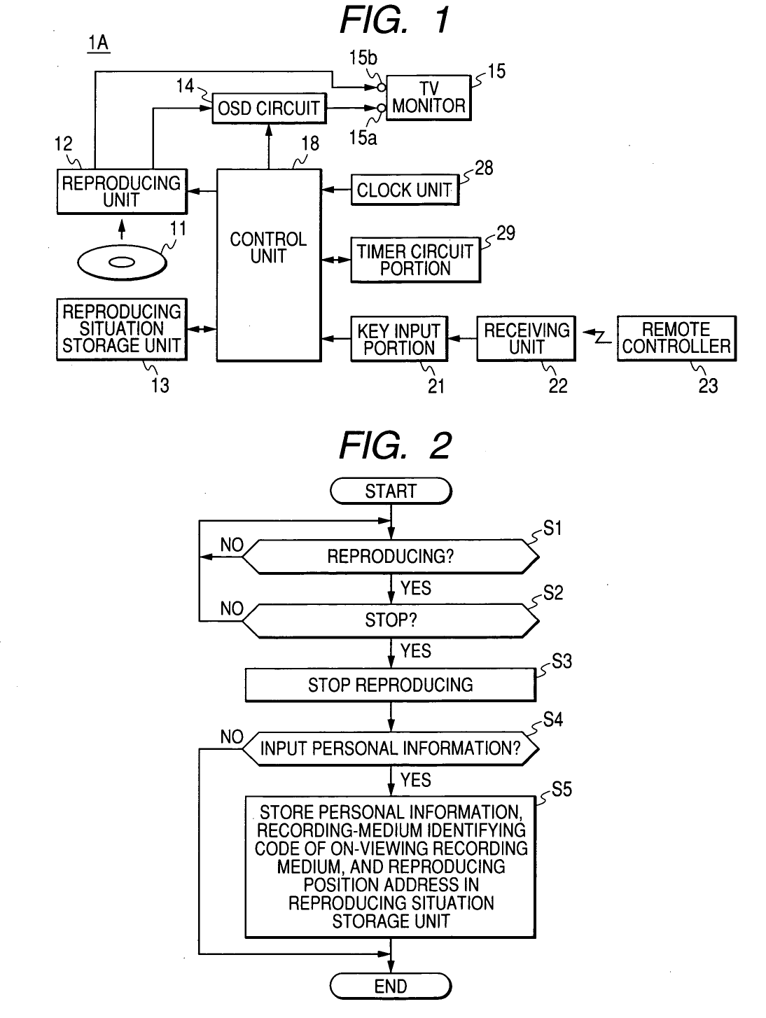

A first example relates to processing operations in case of storing the reproducing situation data in the reproducing situation storage unit 13 during the recording-medium reproducing operation for the recording medium 11. In addition, the first example also relates to processing operations in a case where one person in the family is in an on-viewing state. Now, the first example will be described with reference to a flowchart shown in FIG. 2.

Namely, during the recording-medium reproducing operation for the recording medium 11 performed by the reproducing unit 12 (determined as YES in Step S1), the viewer manipulates a stop key or a pause key (not shown) of the remote controller 23 in order to, for example, go to the restroom or the like, and thus, a stop or pause command is input to the control unit 18 (determined as YES in Step S2). The control unit 18 controls the reproducing unit 12 to stop the recording-medium reproducing operation for the recording medium 11 (Step S3). After that, the control unit 18 monitors whether or not personal information is input (Step S4).

Here, as an example of a method of inputting the personal information, in a case where the family has a father, a mother, a sister, and a brother, an input of father's personal information may be allocated to numerals “0” and “1” of the remote controller 23, an input of mother's personal information may be allocated to numerals “0” and “2” of the remote controller 23, an input of sister's personal information may be allocated to numerals “0” and “3” of the remote controller 23, and an input of brother's personal information may be allocated to numerals “0” and “4” of the remote controller 23, However, the input method is an exemplary one.

Here, for example, in a case where the viewer is the father, when the numerals “0” and “1” are input from the remote controller 23 (determined as YES in Step S4), the reproducing situation data including the input personal data “0, 1”, the recording-medium identifying code (for example, “aaaa”) of the on-reproducing recording medium 11, and the reproducing position information (reproducing position address: for example, “1234”)) at the time of inputting of the personal information are stored in the reproducing situation storage unit 13 (Step S5). On the other hand, after the viewer manipulates the stop key or the pause key, if an input of the personal information is performed in an arbitrary time (for example, 5 seconds) (determined as NO in Step S4), the reproducing situation data is not stored, and the process ends.

### SECOND EXAMPLE

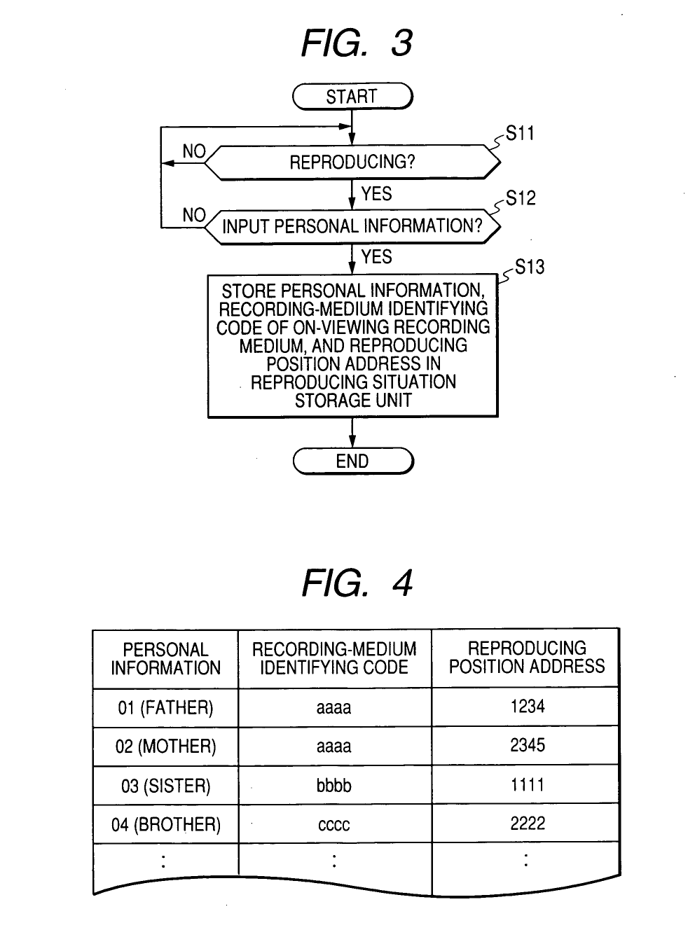

A second example relates to processing operations in case of storing the reproducing situation data in the reproducing situation storage unit 13 during the recording-medium reproducing operation for the recording medium 11. In addition, the second example also relates to processing operations in a case where a plurality of persons are in an on-viewing state. Now, the second example will be described with reference to a flowchart shown in FIG. 3.

Namely, during the recording-medium reproducing operation for the recording medium 11 performed by the reproducing unit 12 (determined as YES in Step S11), an arbitrary viewer (for example, the mother) manipulates keys “0” and “1” of the remote controller 23 in order to go to the restroom or the like, and thus, a stop or pause command is input to the control unit 18 (determined as YES in Step S12). the reproducing situation data including the input personal data “0, 2”, the recording-medium identifying code (for example, “aaaa”) of the on-reproducing recording medium 11, and the reproducing position information (reproducing position address: for example, “2345”)) at the time of inputting of the personal information are stored in the reproducing situation storage unit 13. Namely, in this case, since a plurality of the persons are in the on-viewing state, the reproducing operation is not stopped, and only the personal information is input.

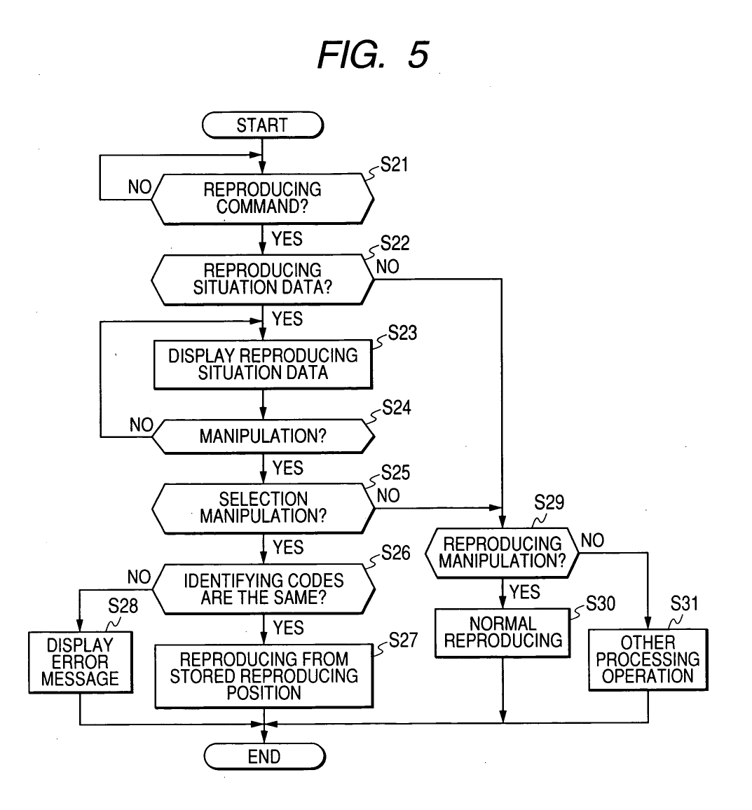

FIG. 4 is a view showing an example of a data structure of the reproducing situation storage unit 13 in which the reproducing situation data according to the first and second examples are stored.

Namely, the reproducing situation data includes items of personal information, recording-medium identifying code, and reproducing position address. In the example, the personal information of the four persons of father, mother, sister, and brother is stored, the recording-medium identifying code “aaaa” for the recording medium 11 corresponding to the father “01” is stored, and the reproducing position address “1234” thereof is stored. In addition, the recording-medium identifying code “aaaa” for the recording medium 11 corresponding to the mother “01” is stored, and the reproducing position address “2345” thereof is stored. Namely, the father and mother are in the on-viewing state for the same program (a movie, a drama, or the like) recorded in the same recording medium 11, and the reproducing position addresses corresponding to the situations thereof are stored.

In addition, in the reproducing situation storage unit 13, the recording-medium identifying code “bbbb” for the recording medium 11 corresponding to the sister “03” is stored, and the reproducing position address “1111” thereof is stored. In addition, in the reproducing situation storage unit 13, the recording-medium identifying code “cccc” for the recording medium 11 corresponding to the brother “04” is stored, and the reproducing position address “2222” thereof is stored. In other word, the sister manipulates the input of the personal information for some reasons during the recording-medium reproducing operation for a different recording medium 11, and the brother also manipulates the input of the personal information for some reasons during the recording-medium reproducing operation for a further different recording medium 11.

### THIRD EXAMPLE

A third example relates to processing operations in a case where a viewer performs a reproducing manipulation in a stopped or paused state. Now, the third example will be described with reference to a flowchart shown in FIG. 5.

Namely, when the viewer manipulates a “reproducing key” (not shown) of the remote controller 23 so that the reproducing command is input to the control unit 18 (determined as YES in Step 21), the control unit 18 refers to the reproducing situation storage unit 13 to determine whether or not the reproducing situation data is stored in the reproducing situation storage unit 13 (Step S22). If the reproducing situation data is determined to be stored (determined as YES in Step S22), the reproducing situation data is displayed on the TV monitor 15. At this time, as a display method thereof, various types may be available, and for example, the example of the data structure shown in FIG. 4 may be displayed.

When the viewer seeing the displayed contents performs manipulation with the remote controller 23 (determined as YES in Step S24), the control unit 18 determines whether or the input manipulation is a manipulation for selecting one data among the reproducing situation data displayed on the TV monitor 15 (Step S25). As described, in a case where the viewer goes to the restroom during the viewing, the viewer returning from the restroom may perform the manipulation. For example, in a case where the viewer is the father, the viewer selects the uppermost data among the reproducing situation data displayed on the TV monitor 15 as shown in FIG. 4. Here, at this time, as an example of the selection manipulation, by manipulating up and down keys (not shown) of the remote controller 23, a cursor is moved to a portion corresponding to the uppermost data displayed on the screen, and by manipulating an enter key (not shown) of the remote controller 23, desired reproducing situation data can be selected.

As a result of the determination in Step S25, if one data is selected as described above (determined as YES Step S25), it is determined whether or not the recording-medium identifying code included in the data and the recording-medium identifying code read out from the currently-loaded recording medium 11 are equal to each other (Step S26). For example, in a case where a leaving time is long, another person may change the recording medium 11, and after the viewing thereof, the recording medium 11 is remained. For the reason, the determination of Step S26 is performed.

As a result of the determination, if the recording-medium identifying codes are equal to each other (determined as YES Step S26, the reproducing starts at the position of the reproducing position address “1234” stored corresponding to the personal specifying information (father “01”) of the aforementioned one data (date including father “01”, recording-medium identifying code “aaaa”, and reproducing position address “1234”) (Step S27). Alternatively, the reproducing may start at a slightly pervious position (for example, a position before 100 seconds in terms of time) of the position of the stored address. On the other hand, when the viewing of the one program (a drama, a movie, or the like) ends, the reproducing situation data for the associated viewer stored in the reproducing situation storage unit 13 may be automatically erased. Accordingly, it is possible to solve the problem in that unnecessary reproducing situation data is remained in the reproducing situation storage unit 13.

On the other hand, as a result of the determination of Step S26, if the recording-medium identifying codes are not equal to each other (determined as NO Step S26), since another person is likely to change the recording medium 11 during the leaving time of the father, an error message, for example, a message “The currently-loaded disk is different from your on-viewing disk” is displayed on the TV monitor 15 (Step S28). Therefore, the viewer can change the currently-loaded recording medium with the on-viewing recording medium and input the reproducing command again. Accordingly, the processing operations repeat from Step S21.

On the other hand, if the reproducing situation data are not stored in the reproducing situation storage unit 13 (determined as NO Step S22) and if the manipulation performed by the viewer is not the selection manipulation with reference to the reproducing situation data (determined as NO Step S25), the processing operation proceeds to Step S29, and it is determined whether or not the input manipulation of the reproducing key of the remote controller 23 is the reproducing command. As a result of the determination, if the input manipulation is the reproducing command (determined as YES Step S29), the reproducing starts from the first position as a normal case (Step S30). On the other hand, if the input manipulation is not the reproducing command (determined as NO Step S29), the processing operations are performed according to the input manipulation (Step S31).

### Second Embodiment

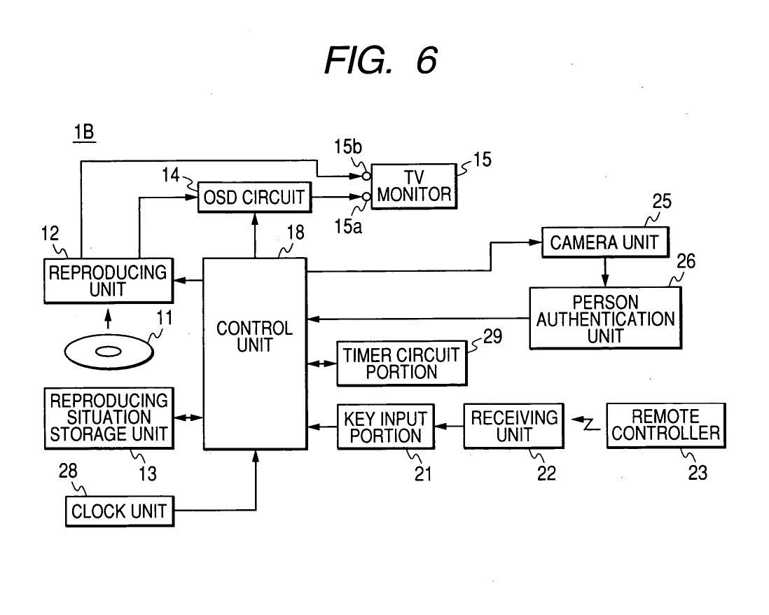

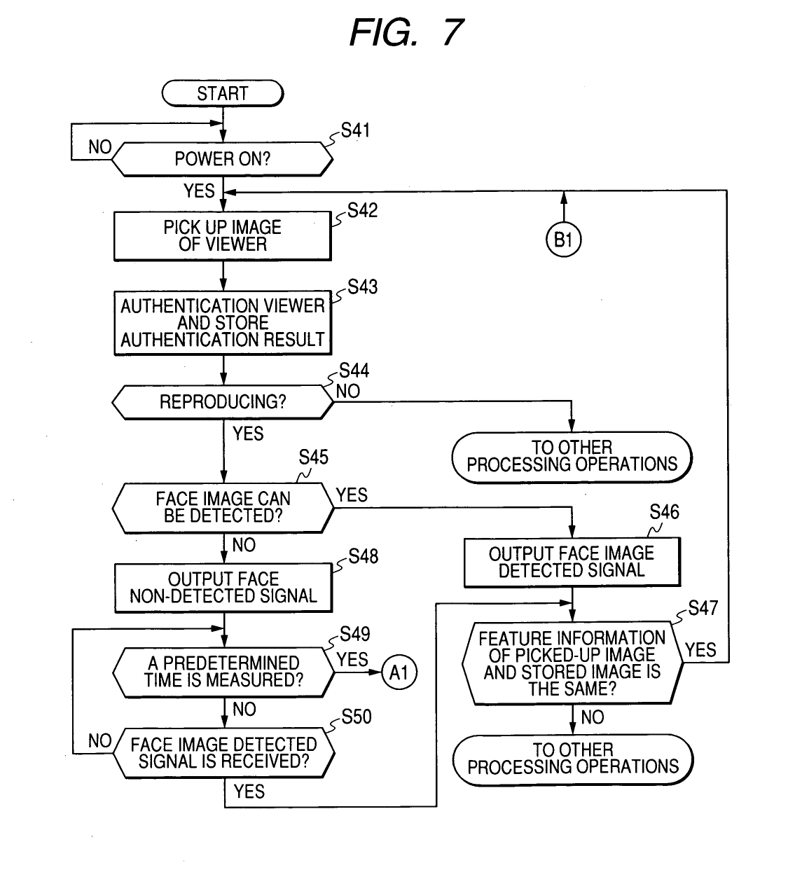

FIG. 6 is a functional block diagram showing a whole construction of an image reproducing apparatus according to a second embodiment of the invention. In the image reproducing apparatus 1B according to the second embodiment, persons is specified by using an authentication technique, so that reproducing situations of persons can be individually managed.

The image reproducing apparatus 1B according to the second embodiment includes a reproducing unit 12 for reproducing a recording medium (image media) such as DVDs, and the reproducing unit 12 is connected to a later-described control unit 18. In addition, a reproduced sound output of the reproducing unit 12 is connected to a sound input port 15b of a TV monitor 15. A reproduced image output of the reproducing unit 12 is connected to an image input port 15a of the TV monitor 15 through an OSD (on-screen display) circuit 14.

Although not shown, the control unit 18 is constructed with a CPU, a ROM, a RAM, and the like to control the reproducing unit 11 and the OSD circuit 14. A reproducing situation storage unit 13 for storing reproducing situation data of a single one viewer or a plurality of viewers is connected to the control unit 18 in a bi-directional manner. EPROMs, EEPROMs, Flash memories, or the like may used for the reproducing situation storage unit 13.

In addition, a key input portion 21 for inputting various key manipulation signals to the control unit 18 is connected to the control unit 18, and a receiving unit 22 for receiving the key manipulation signals from a remote controller 23 is connected to the key input portion 21. Namely, the key input portion 21 is designed to input the key manipulation signals received through the receiving unit 22 from the remote controller 23 as well as manipulation signals of various keys (buttons) disposed on a front panel of an apparatus main body. In addition, a clock unit 28 for indicating a current time and a later-described timer circuit unit 29 for measuring various times are connected to the control unit 18.

In addition, a camera unit, that is, an image pickup unit (a CCD camera unit) 25 for picking up an image of the viewer is provided to a main body of the apparatus. An output of the camera unit 25 is connected to a person authentication unit 26 for detecting a face image from the picked-up image and authenticating a person based on the detected face image, and an authentication result of the person authentication unit 26 is input to the control unit 18. In addition, the person authentication unit 26 also has function of determining opened and closed states of eyes based on the detected face image.

In the construction, information on physical features (face features in the second embodiment) of all members of a family is stored in an internal memory (not shown) of the person authentication unit 26. In an example of a storing method thereof, a menu button (not shown) of the remote controller 23 may be manipulated to select a recognition information registering mode. The recognition information registering mode denotes a mode for performing a process for storing feature information of an object recognized by the person authentication unit 26 in a memory unit in advance.

More specifically, in case of forming recognition data of, for example, a child, a face image of the child is picked up by the camera unit 25 which is separated by a predetermined distance from the child. The person authentication unit 26 forms the child recognition data based on the picked-up face image. An image recognition technique is well-known in the related art, and thus, detailed description thereof is omitted. The child recognition data (feature data) are stored in the internal memory. After that, the person authentication unit 26 authenticates a specific person based on the recognition data stored in the internal memory.

In the image reproducing apparatus 1B according to the second embodiment, the control unit 18 is designed to perform an automatic reproducing process according to a situation of a viewer by elaborately combining a person authentication technique of the person authentication unit 26 and a detection technique for detecting an absence or sleeping state of the viewer with the producing operations.

Now, detailed examples of the automatic reproducing process of the control unit 18 will be descried.

### FOURTH EXAMPLE

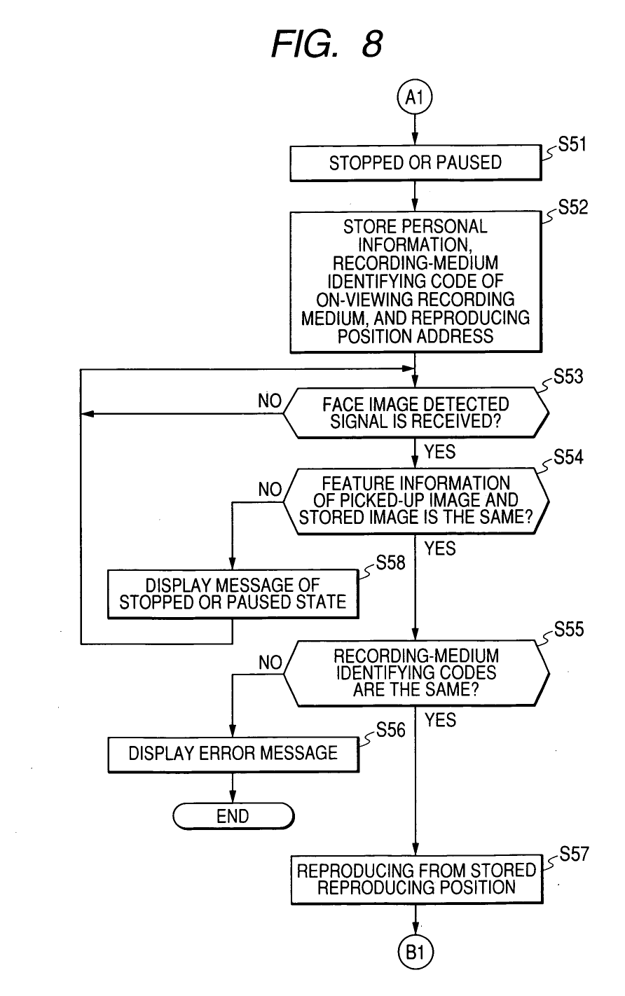

FIGS. 7 and 8 are flowcharts showing the automatic reproducing process according to the fourth example. The fourth example relates to a case where a viewer left from a front of the image reproducing apparatus 1B (that is, the TV monitor 15) returns.

For example, when the TV is powered on by using the remote controller 23 (determined as YES in Step S41), the control unit 18 controls the camera unit 25 to start picking up an image of the viewer (Step S42).

The person authentication unit 26 authenticates (specifies) the viewer by comparing feature information of the face image of the viewer picked up by the camera unit 25 with feature information of the face images of all the members of the family registered in advance in the internal memory and stores the authentication result in the internal memory (Step S43).

After that, the control unit 18 incessantly checks whether or not the reproducing operation is performed (Step S44) and, the person authentication unit 26 determines during the reproducing operation, for example, in units of 1 to 2 seconds whether or not the face image can be detected from the picked-up image of the camera unit 25 (Step S45). Next, if the face image can be detected (determined as YES in Step S45), a face image detected signal is output to the control unit 18 (Step S46), and the feature information of the face image is compared with the feature information of the face image of the specific person stored in the internal memory to incessantly checks whether or not the currently-viewing person is the same as the specific person (Step S47). If the currently-viewing person is the same as the specific person, the process returns to Step S42 and the processing operations repeat therefrom.

On the other hand, if the face image cannot be detected (determined as NO in Step S45), the face image non-detected signal is output to the control unit 18 (Step S48).

The control unit 18 incessantly monitors signals from the person authentication unit 26. Next, when the face image detected signal is received from the person authentication unit 26, a timer circuit unit 29 is driven to start measuring a predetermined time (for example, 5 seconds) (Step S49), and it is determined whether or not the face image detected signal is received from the person authentication unit 26 (Step S50). As a result of the determination, when the face image detected signal is received in a predetermined time (determined as NO in Step S49 and as YES in Step S50), the processing operations proceed to Step S47.

On the other hand, when the face image detected signal is not received in a predetermined time elapses (determined as YES in Step S49), the viewer is not determined to be in front of the TV monitor 15 (that is, in front of the image reproducing apparatus 1B), so that the reproducing operation is stopped or paused (Step S51). At this time, the reproducing situation data including the person specifying (person specifying (authenticating) information stored in the internal memory), the recording-medium identifying code (for example, “aaaa”) of the on-reproducing recording medium 11, and the reproducing position address (for example, “1234”)) at the time of inputting of the personal information are stored in the reproducing situation storage unit 13 (Step S52). Here, the reproducing situation data stored in the reproducing situation storage unit 13 are substantially the same as the data shown in FIG. 4, but there is a different point in terms of the information stored in the item of the personal information. Namely, in the first embodiment, the information is a two-digit code based on the key input manipulation of the remote controller 23, but in the fourth example, the information is the personal information authenticated by the person authentication unit 26.

In this state, the control unit 18 incessantly checks whether or not the face image detected signal is received from the person authentication unit 26 (Step S53). Next, when the face image detected signal is received (determined as YES in Step S53), the feature information of the face image picked up by the camera unit 25 is compared with the feature information of the face image of the specific person stored in the internal memory to determine whether or not the returning person is the same as the original person (Step S54). If the returning person is determined to be the same as the original person ((determined as YES in Step S54), the recording-medium identifying code of the loaded recording medium 11 is compared with the recording-medium identifying code “aaaa” stored corresponding to the person specifying information of the person who is determined to be same person (Step S55). When the two recording-medium identifying codes are equal to each other (determined as YES in Step S55), The reproducing operation starts at the position indicated by the reproducing position address stored corresponding to the person specifying information (Step S57). Alternatively, the reproducing operation may start at a slightly pervious position of the stored reproducing position “1234”. After that, the process returns to Step S42 and the processing operations repeat therefrom.

On the other hand, if the recording-medium identifying codes are not equal to each other (determined as NO Step S55), an error message (for example, a message “The currently-loaded disk is different from your on-viewing disk”) is displayed on the TV monitor 15 (Step S56). Therefore, the viewer can change the currently-loaded recording medium 11 with the on-viewing recording medium and input the reproducing command again. Accordingly, the processing operations repeat from Step S45.

On the other hand, if it is determined as NO in Step S54, that is, if the returning person is not the same as the original person, it is notified to the viewer that the apparatus is in the stopped or paused state (Step S58), and the processing operation returns to Step S53. At this time, as a notification method, screen display on the TV monitor 15 is generally used. Alternatively, notification using sounds, notification of lightening up and out a display portion such as LEDs, or a combination thereof may be used.

On the other hand, in the fourth example, if the returning person is determined to be the same as the original person, the reproducing operation returns to the stored reproducing position and automatically starts therefrom in Step S53. However, before the reproducing is automatically performed, the viewer may be allowed to select where or not to perform the automatic reproducing. Namely, in a case where the time that viewer is not in front of the TV monitor 15 is relatively short, some viewers may consider to skip the passed time and keep on viewing. Therefore, since the returning viewer is allowed to select whether or not to view the passed scenes backwardly, so that it is possible to implement an apparatus which can be flexibly used according to the viewer's intentions.

In addition, in the fourth example, if the returning person is not the same as the original person (determined as NO in Step S54), it is notified that the apparatus is in the stopped or paused state. However, irrespective of the notification, other persons are likely to perform power-on or reproducing manipulation as a mistake. Therefore, in a case where it is determined as NO in Step S54, the control unit 18 may invalidate manipulation input of other persons to maintain the apparatus in the stopped or paused state. In this case, an alarm that any input is invalid may be displayed on the screen of the TV monitor 15. Accordingly, it is possible to securely preventing other person from performing inadvertent manipulations.

In addition, in the fourth embodiment, if the face image detected signal is not received in a predetermined time in Step S49, it is determined that the viewer is not in front of the TV monitor 15 (that is, in front of the image reproducing apparatus 1B), and thus, the reproducing operation is stopped or paused (Step S51). Alternatively, in this case, the reproducing operation may not be stopped, but in the next step S52, only the reproducing situation data including the person specifying information at the time thereof, the recording-medium identifying code of the on-production recording medium 11, and the reproducing position address at the time of inputting the person specifying information may be stored in the reproducing situation storage unit 13. Accordingly, in a case where several persons view the same drama or movie, although one person is not in the location of the apparatus, viewing of other person is not interrupted.

### FIFTH EXAMPLE

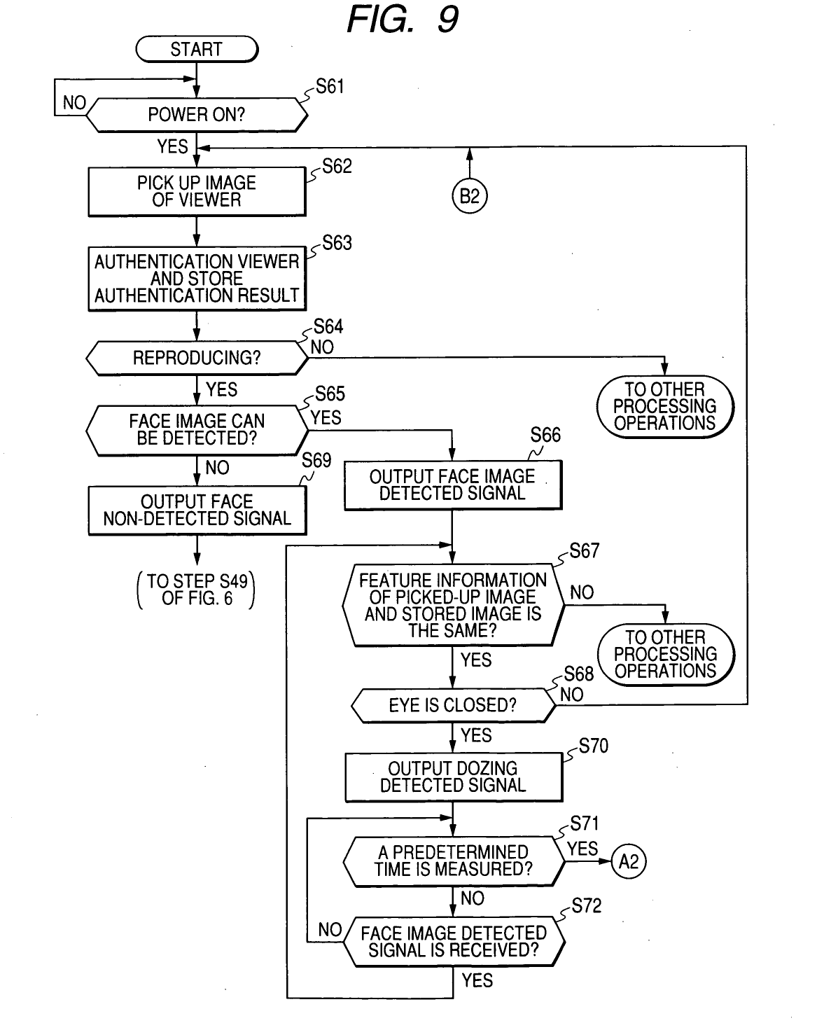

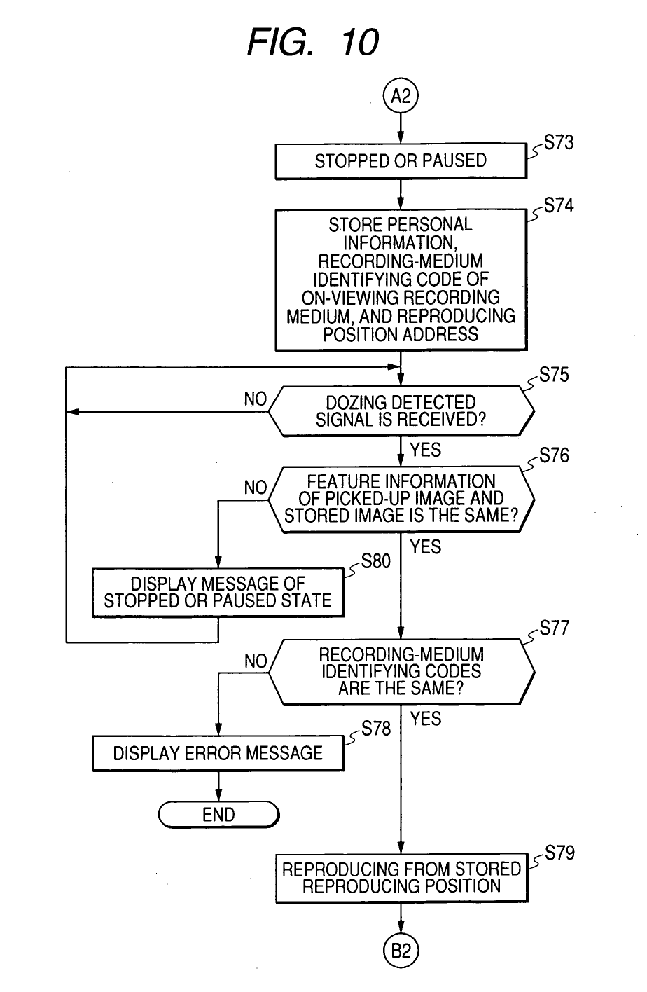

FIGS. 9 and 10 are flowcharts showing the automatic reproducing process according to the fifth example. The fifth example relates to a case where a viewer is dozing off in front of the TV monitor 15 (that is, in front of the image reproducing apparatus 1B).

For example, when the TV is powered on by using the remote controller 23 (determined as YES in Step S61), the control unit 18 controls the camera unit 25 to start picking up an image of the viewer (Step S62).

The person authentication unit 26 authenticates (specifies) the viewer by comparing feature information of the face image of the viewer picked up by the camera unit 25 with feature information of the face images of all the members of the family registered in advance in the internal memory and stores the authentication result in the internal memory (Step S63).

After that, the control unit 18 incessantly checks whether or not the reproducing operation is performed (Step S64), and the person authentication unit 26 determines during the reproducing operation, for example, in units of 1 to 2 seconds whether or not the face image can be detected from the picked-up image of the camera unit 25 (Step S65). Next, if the face image can be detected (determined as YES in Step S65), a face image detected signal is output to the control unit 18 (Step S66). And, the feature information of the face image is compared with the feature information of the face image of the specific person stored in the internal memory to incessantly checks whether or not the currently-viewing person is the same as the specific person (Step S67), and opened and closed states of eyes are incessantly determined from the face image of the viewer picked up by the camera unit 25 (Step S68). As a result of the determination, if the currently-viewing person is the same as the specific person and if the eyes are in the opened state (determined as YES in Step S68), the process returns to Step S62 and the processing operations repeat therefrom.

On the other hand, if the face image cannot be detected (determined as NO in Step S65), the face image non-detected signal is output to the control unit 18 (Step S69). On the other hand, the processing operations of the control unit 18 after receiving the face image detected signal are the same as those after Step S49 shown in FIG. 7, and thus, hereinafter, description thereof will be omitted.

In addition, if the eyes are in the closed state (determined as NO in Step S68), an dozing detected signal indicating a dozing state is output to the control unit 18 (Step S70).

The control unit 18 incessantly monitors signals from the person authentication unit 26. Next, when the dozing detected signal is received from the person authentication unit 26, a timer circuit unit 29 is driven to start measuring a predetermined time (for example, 5 seconds) (Step S71), and it is determined whether or not the dozing detected signal is received from the person authentication unit 26 (Step S72). As a result of the determination, when the dozing detected signal is not received in a predetermined time (determined as NO in Step S71 and as YES in Step S72), the processing operations proceed to Step S67.

On the other hand, when the dozing detected signal is received in a predetermined time elapses (determined as YES in Step S71), the viewer is determined to be dozing with the eyes closed in a predetermined time or more in front of the TV monitor 15 (that is, in front of the image reproducing apparatus 1B), so that the reproducing operation is stopped or paused (Step S73). At this time, the reproducing situation data including the person specifying (person specifying (authenticating) information stored in the internal memory), the recording-medium identifying code (for example, “aaaa”) of the on-reproducing recording medium 11, and the reproducing position address (for example, “1234”)) at the time of inputting of the personal information are stored in the reproducing situation storage unit 13 (Step S74). Here, the reproducing situation data stored in the reproducing situation storage unit 13 are substantially the same as those of the fourth example.

In this state, the control unit 18 incessantly checks whether or not the dozing detected signal is received from the person authentication unit 26 (Step S75). Next, when the dozing detected signal is not received (determined as YES in Step S75), the viewer is determined to open eyes, and the feature information of the face image picked up by the camera unit 25 is compared with the feature information of the face image of the specific person stored in the internal memory to determine whether or not the person is the same as the original person (Step S76). If the person is determined to be the same as the original person (determined as YES in Step S76), the recording-medium identifying code of the loaded recording medium 11 is compared with the recording-medium identifying code “aaaa” stored corresponding to the person specifying information of the person who is determined to be same person (Step S77). When the two recording-medium identifying codes are equal to each other (determined as YES in Step S77), The reproducing operation starts at the position indicated by the reproducing position address stored corresponding to the person specifying information (Step S79). Alternatively, the reproducing operation may start at a slightly pervious position of the stored reproducing position “1234”. After that, the process returns to Step S62 and the processing operations repeat therefrom.

On the other hand, if the recording-medium identifying codes are not equal to each other (determined as NO Step S77), an error message (for example, a message “The currently-loaded disk is different from your on-viewing disk”) is displayed on the TV monitor 15 (Step S78). Therefore, the viewer can change the currently-loaded recording medium 11 with the on-viewing recording medium and input the reproducing command again. Accordingly, the processing operations repeat from Step S65.

On the other hand, if it is determined as NO in Step S76, that is, if the person is not the same as the original person, it is notified to the viewer that the apparatus is in the stopped or paused state (Step S80), and the processing operation returns to Step S75. At this time, as a notification method, screen display on the TV monitor 15 is generally used. Alternatively, notification using sounds, notification of lightening up and out a display portion such as LEDs, or a combination thereof may be used.

On the other hand, in the fifth example, if the person with the eyes opened is determined to be the same as the original person, the reproducing operation returns to the stored reproducing position and automatically starts therefrom in Step S765. However, before the reproducing is automatically performed, the viewer may be allowed to select where or not to perform the automatic reproducing. Namely, in a case where the time that viewer is not in front of the TV monitor 15 is relatively short, some viewers may consider to skip the passed time and keep on viewing. Therefore, since the viewer awakened from dozing is allowed to select whether or not to view the passed scenes backwardly, so that it is possible to implement an apparatus which can be flexibly used according to the viewer's intentions.

In addition, in the fifth example, if the person awaked from dozing is not the same as the original person (determined as NO in Step S76) (although it is unrealistic), it is notified that the apparatus is in the stopped or paused state. However, irrespective of the notification, other persons are likely to perform power-on or reproducing manipulation as a mistake. Therefore, in a case where it is determined as NO in Step S76, the control unit 18 may invalidate manipulation input of other persons to maintain the apparatus in the stopped or paused state. In this case, an alarm that any input is invalid may be displayed on the screen of the TV monitor 15. Accordingly, it is possible to securely preventing other person from performing inadvertent manipulations.

In addition, in the fifth embodiment, if the dozing detected signal is received in a predetermined time in Step S71, it is determined that the viewer is in the dozing state, and thus, the reproducing operation is stopped or paused (Step S73). Alternatively, in this case, the reproducing operation may not be stopped, but in the next step S74, only the reproducing situation data including the person specifying information at the time thereof, the recording-medium identifying code of the on-production recording medium 11, and the reproducing position address at the time of inputting the person specifying information may be stored in the reproducing situation storage unit 13. Accordingly, in a case where several persons view the same drama or movie, although one person is in the dozing state, viewing of other person is not interrupted.

In addition, in the fifth example, if the dozing detected signal is received in a predetermined time in Step S71, it is determined that the viewer is in the dozing state, and thus, the reproducing operation is stopped or paused (Step S73). In stead of stopping the apparatus abruptly, the reproducing operation may be continuously performed, and a sound fade out operation may start. After an arbitrary time (for example, 1 to 2 seconds) elapses from the time that a sound output is in minimum, the reproducing operation may be stopped. Accordingly, it is possible not to interrupt sleeping of the viewer. In addition, since unnecessary reproducing operation can be ended, so that it is possible to reduce power consumption.

### SIXTH EXAMPLE

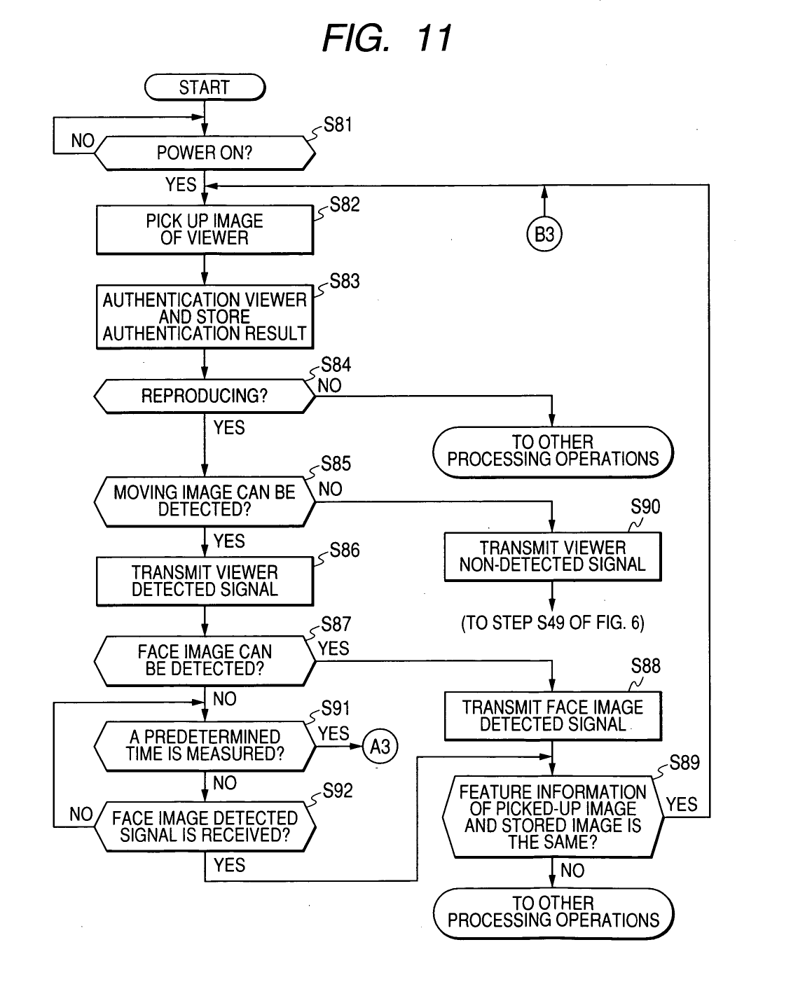

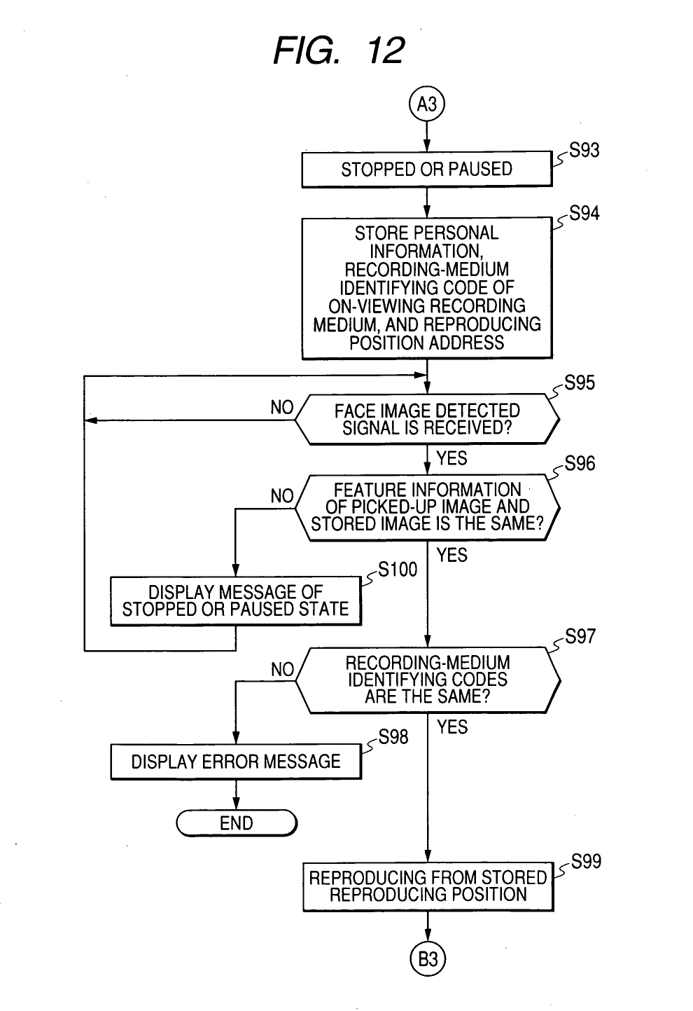

FIGS. 11 and 12 are flowcharts showing the automatic reproducing process according to the sixth example. The sixth example relates to a case where, although a viewer is in front of the TV monitor 15 (that is, in front of the image reproducing apparatus), it cannot be determined whether or not the viewer actually views the on-reproducing program (for example, a case where the viewer viewing the TV monitor 15 performs another task).

When the TV is powered on by using the remote controller 23 (determined as YES in Step S81), the control unit 18 controls the camera unit 25 to start picking up an image of the viewer (Step S82).

The person authentication unit 26 authenticates (specifies) the viewer by comparing feature information of the face image of the viewer picked up by the camera unit 25 with feature information of the face images of all the members of the family registered in advance in the internal memory and stores the authentication result in the internal memory (Step S83).

After that, the control unit 18 incessantly checks whether or not the reproducing operation is performed (Step S64), and the person authentication unit 26 determines during the reproducing operation, for example, in units of 1 to 2 seconds whether or not a moving object can be detected from the picked-up image of the camera unit 25 (Step S85). Next, if the moving object can be detected (determined as YES in Step S85), a viewer detected signal is output to the control unit 18 (Step S86). Next, the person authentication unit 26 determines whether or not a face image can be detected from the picked-up image of the camera unit 25 (Step S87). Next, if the face image can be detected (determined as YES in Step S87), the face image detected signal is output to the control unit 18 (Step S88). And, the feature information of the face image is compared with the feature information of the face image of the specific person stored in the internal memory to incessantly checks whether or not the currently-viewing person is the same as the specific person (Step S89), As a result of the determination, if the currently-viewing person is the same as the specific person, the process returns to Step S82 and the processing operations repeat therefrom.

The control unit 18 incessantly monitors signals from the person authentication unit 26. On the other hand, if the moving object cannot be detected (determined as NO in Step S85), the viewer non-detected signal is output to the control unit 18 (Step S90). On the other hand, the processing operations of the control unit 18 after receiving the viewer non-detected signal are the same as those after Step S49 shown in FIG. 7, and thus, hereinafter, description thereof will be omitted.

In addition, in the control unit 18, when the viewer detected signal is received from the person authentication unit 26, if the face image non-detected signal is also received therefrom (determined as YES in Step S85 and as No in Step 87), a timer circuit unit 29 is driven to start measuring a predetermined time (for example, 5 seconds) (Step S91), and it is determined whether or not the face image detected signal is received from the person authentication unit 26 (Step S92). As a result of the determination, when the face image detected signal is received in a predetermined time (determined as NO in Step S91 and as YES in Step S92), the processing operations proceed to Step S89.

On the other hand, when the face image detected signal is not received in a predetermined time elapses (determined as YES in Step S91), it cannot be determined whether or not the viewer views the on-reproducing program, so that the reproducing operation is stopped or paused (Step S93). At this time, the reproducing situation data including the person specifying (person specifying (authenticating) information stored in the internal memory), the recording-medium identifying code (for example, “aaaa”) of the on-reproducing recording medium 11, and the reproducing position address (for example, “1234”)) at the time of inputting of the personal information are stored in the reproducing situation storage unit 13 (Step S94). Here, the reproducing situation data stored in the reproducing situation storage unit 13 are substantially the same as those of the fifth example.

In this state, the control unit 18 incessantly checks whether or not the face image detected signal is received from the person authentication unit 26 (Step S95). Next, when the face image detected signal is received (determined as YES in Step S95), the feature information of the face image picked up by the camera unit 25 is compared with the feature information of the face image of the specific person stored in the internal memory to determine whether or not the person of which face image is detected is the same as the original person (Step S96). If the person of which face image is detected is determined to be the same as the original person (determined as YES in Step S96), the recording-medium identifying code of the loaded recording medium 11 is compared with the recording-medium identifying code “aaaa” stored corresponding to the person specifying information of the person who is determined to be same person (Step S97). When the two recording-medium identifying codes are equal to each other (determined as YES in Step S97), The reproducing operation starts at the position indicated by the reproducing position address stored corresponding to the person specifying information (Step S99). Alternatively, the reproducing operation may start at a slightly pervious position of the stored reproducing position “1234”. After that, the process returns to Step S82 and the processing operations repeat therefrom.

On the other hand, if the recording-medium identifying codes are not equal to each other (determined as NO Step S97), an error message (for example, a message “The currently-loaded disk is different from your on-viewing disk”) is displayed on the TV monitor 15 (Step S98). Therefore, the viewer can change the currently-loaded recording medium 11 with the on-viewing recording medium and input the reproducing command again. Accordingly, the processing operations repeat from Step S85.

On the other hand, if it is determined as NO in Step S96, that is, if the person is not the same as the original person, it is notified to the viewer that the apparatus is in the stopped or paused state (Step S100), and the processing operation returns to Step S95. At this time, as a notification method, screen display on the TV monitor 15 is generally used. Alternatively, notification using sounds, notification of lightening up and out a display portion such as LEDs, or a combination thereof may be used.

On the other hand, in the sixth example, if the person of which face image is detected is determined to be the same as the original person (determined as NO in Step S96), it is notified that the apparatus is in the stopped or paused state. However, irrespective of the notification, other persons are likely to perform power-on or reproducing manipulation as a mistake. Therefore, in a case where it is determined as NO in Step S96, the control unit 18 may invalidate manipulation input of other persons to maintain the apparatus in the stopped or paused state. In this case, an alarm that any input is invalid may be displayed on the screen of the TV monitor 15. Accordingly, it is possible to securely prevent other persons from performing inadvertent manipulations.

In addition, in the sixth embodiment, if the face image detected signal is not received in a predetermined time in Step S91, it is cannot be determined whether or not the viewer views the on-reproducing program, and thus, the reproducing operation is stopped or paused (Step S93). Alternatively, in this case, the reproducing operation may not be stopped, but in the next step S94, only the reproducing situation data including the person specifying information at the time thereof, the recording-medium identifying code of the on-production recording medium 11, and the reproducing position address at the time of inputting the person specifying information may be stored in the reproducing situation storage unit 13. Accordingly, in a case where several persons view the same drama or movie, although one person is not in the location of the apparatus, viewing of other person is not interrupted.

On the other hand, in the fourth to sixth examples, when the viewing of the one program (a drama, a movie, or the like) ends, the reproducing situation data for the associated viewer stored in the reproducing situation storage unit 13 may be automatically erased. Accordingly, it is possible to solve the problem in that unnecessary reproducing situation data is remained in the reproducing situation storage unit 13.

### SEVENTH EXAMPLE

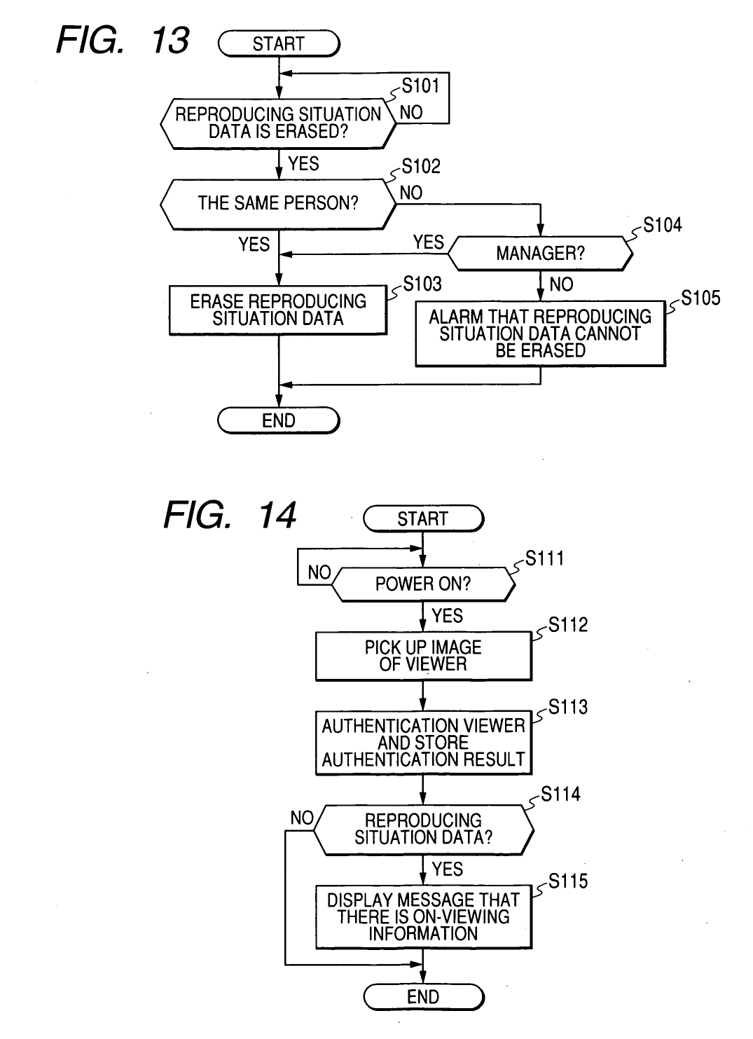

FIG. 13 is a flowchart showing processing operations according to a seventh example which relates to a case where information recorded in a recording medium 11 is manually erased.

In a case where it is intended to erase arbitrary reproducing situation data stored in a reproducing situation storage unit 13 by manipulating a remote controller 23 (determined as YES in Step 101), The person authentication unit 26 authenticates (specifies) the viewer by comparing feature information of the face image of the viewer picked up by the camera unit 25 with feature information of the face images of all the members of the family registered in advance in the internal memory and determines whether or not the to-be-erased person is the same as the person included in the reproducing situation data by comparing the viewer's information (person specifying information) with the person specifying information included in the to-be-erased reproducing situation data (Step S102). As a result of the determination, if the persons are the same (determined as YES in Step S102), only the to-be-erased reproducing situation data are erased (Step S103).

On the other hand, as a result of Step S102, if the persons are not the same (determined as NO in Step 102), it is determined whether or not the person is a manager (registered in advance) (Step S104). As a result of the determination, if the person is the manager (determined as YES in Step S104), only the to-be-erased reproducing situation data are erased (Step S103). On the other hand, if the person is not a manager (determined as No in Step S104), an alarm message that the reproducing situation data cannot be erased is displayed on the TV monitor 15 (Step S105).

### EIGHTH EXAMPLE

FIG. 14 is a flowchart showing processing operations according to an eighth example which relates to a case where a presence of on-viewing information is notified to a viewer at the time of power-on.

When the TV is powered on by using the remote controller 23 (determined as YES in Step S111), the control unit 18 controls the camera unit 25 to start picking up an image of the viewer (Step S112).

The person authentication unit 26 authenticates (specifies) the viewer by comparing feature information of the face image of the viewer picked up by the camera unit 25 with feature information of the face images of all the members of the family registered in advance in the internal memory and stores the authentication result (that is, the feature information of the specific person who is currently in a on-viewing stage) in the internal memory (Step S113).

Next, the control unit 18 determines whether or not the person specifying information of the authenticated viewer is included in various reproducing situation data stored in the reproducing situation storage unit 13 (Step S114). As a result of the determination, if the person specifying information of the viewer is included in arbitrary reproducing situation data (determined as YES in Step S114), a message notifying to the viewer that there is on-viewing information (a drama, a movie, or the like) is displayed on the TV monitor 15 (Step S115). Accordingly, the viewer can recognize that another viewer views the on-viewing information.

What is claimed is:

1. An image reproducing apparatus comprising:
a reproducing unit for reproducing information recorded in a recording medium;
a image pickup unit for picking up an image of a viewer;
a face image detecting unit for detecting a face image from the image of the viewer picked up by the image pickup unit;
an authentication unit for authenticating a on-viewing person by comparing the face image of the viewer detected by the face image detecting unit with a face image of a previously-registered person;
a reproducing control unit for controlling recording-medium reproducing operation of the reproducing unit;
an eye opened/closed state determination unit for determining opened and closed states of eyes from the face image detected by the face image detecting unit; and
a reproducing situation storage unit for storing reproducing situations of a single one viewer or a plurality of viewers, wherein:
under the control of the reproducing control unit, during the recording-medium reproducing operation, if the eye opened/closed state determination unit determines that the eyes are closed in a predetermined time or more, the reproducing situation data including previously detected face image information, reproducing position information at the time of the eyes closed, and recording-medium identifying information of the on-reproducing recording medium are stored in the reproducing situation storage unit; the reproducing operation is continuously performed and a fade out operation starts; and after an arbitrary time elapses from the time that a sound output is in minimum, the reproducing operation is stopped; and
under the control of the reproducing control unit, during the recording-medium reproducing operation, if the eye opened/closed state determination unit determines that the eyes are opened again and, as a result of the determination, if the person is the same as a person of the face image information stored in the reproducing situation storage unit, the reproducing operation starts at the reproducing position stored corresponding to the face image information or at a slightly pervious position thereof.

2. An image reproducing apparatus comprising:
a reproducing unit for reproducing information recorded in a recording medium;
a personal information registering unit for registering personal information in advance;
an input unit for performing inputting various information;
a reproducing control unit for controlling recording-medium reproducing operation of the reproducing unit; and
a reproducing situation storage unit for storing reproducing situations of a single one viewer or a plurality of viewers, wherein
under the control of the reproducing control unit, during a recording-medium reproducing operation, when person specifying information is input from the input unit, recording situation data including recording-medium identifying information of on-reproducing recording medium, reproducing position information at the time of inputting of personal information, and the input person specifying information are stored in the reproducing situation storage unit; when reproducing command information and person specifying information are input from the input unit, the input person specifying information and the person specifying information stored in the reproducing situation storage unit are compared with each other; if both information are equal to each other, recording-medium identifying information of a loaded recording medium and the recording-medium identifying information stored corresponding to the person specifying information are compared with each other; and if both recording-medium identifying information are equal to each other, the reproducing operation starts at a reproducing position stored corresponding to the person specifying information or at a slightly pervious position thereof.

3. An image reproducing apparatus comprising:
a reproducing unit for reproducing information recorded in a recording medium;
a personal information registering unit for registering personal information in advance;
an input unit for performing inputting various information; and
a reproducing control unit for controlling recording-medium reproducing operation of the reproducing unit; and
a reproducing situation storage unit for storing reproducing situations of a single one viewer or a plurality of viewers, wherein
under the control of the reproducing control unit, during a recording-medium reproducing operation, when reproducing stop information and person specifying information are input from the input unit, The recording-medium reproducing operation is stopped or paused, and recording situation data including recording-medium identifying information of on-reproducing recording medium, reproducing stop information, and the input person specifying information are stored in the reproducing situation storage unit; when reproducing command information and person specifying information are input from the input unit, the input person specifying information and the person specifying information stored in the reproducing situation storage unit are compared with each other; if both information are equal to each other, recording-medium identifying information of a loaded recording medium and the recording-medium identifying information stored corresponding to the person specifying information are compared with each other; and if both recording-medium identifying information are equal to each other, the reproducing operation starts at a reproducing stop position stored corresponding to the person specifying information or at a slightly pervious position thereof.

4. The image reproducing apparatus according to claim 2 or 3, wherein
in the stop state of the reproducing operation, when manipulation information is input from the input unit, if a single reproducing situation data or a plurality of reproducing data are stored in the reproducing situation storage unit, the image reproducing apparatus further comprises a display unit for displaying the reproducing situation data.

5. The image reproducing apparatus according to claim 4, wherein
a single reproducing situation data is selected from the reproducing situation data displayed on the display unit by using the input unit, so that the reproducing control unit starts the reproducing operation based on the selected reproducing situation data.

6. An image reproducing apparatus comprising:
a reproducing unit for reproducing information recorded in a recording medium;
a image pickup unit for picking up an image of a viewer;
a face image detecting unit for detecting a face image from the image of the viewer picked up by the image pickup unit;
an authentication unit for authenticating a on-viewing person by comparing the face image of the viewer detected by the face image detecting unit with a face image of a previously-registered person;
a reproducing control unit for controlling recording-medium reproducing operation of the reproducing unit; and
a reproducing situation storage unit for storing reproducing situations of a single one viewer or a plurality of viewers, wherein
under the control of the reproducing control unit, during a recording-medium reproducing operation, if the face image cannot be detected by the face image detecting unit in a predetermined time or more, the reproducing situation data including previously detected face image information, reproducing position information at the time that the face image cannot be detected, and recording-medium identifying information of the on-reproducing recording medium are stored in the reproducing situation storage unit; if the face image is detected by the face image detecting unit, and as a result of the authentication of the authentication unit, if the person is the same as a person of the face image information stored in the reproducing situation storage unit, recording-medium identifying information of a loaded recording medium and the recording-medium identifying information stored corresponding to the face image information are compared with each other; and if both recording-medium identifying information are equal to each other, the reproducing operation starts at the reproducing position stored corresponding to the face image information or at a slightly pervious position thereof.

7. The image reproducing apparatus according to claim 6, wherein
under the control of the control unit, during the recording-medium reproducing operation, if the face image cannot be detected by the face image detecting unit in a predetermined time or more, the reproducing operation is stopped or paused at the time thereof.

8. The image reproducing apparatus according to claim 6, wherein
under the control of the control unit, if the time that the face image cannot be detected by the face image detecting unit is within a predetermined time or less, the reproducing operation is not stopped or paused but continuously performed.

9. The image reproducing apparatus according to claim 7, wherein
under the control of the control unit, if the face image is detected by the face image detecting unit, and as a result of the authentication of the authentication unit, if the person is not the same as a person of the face image information stored in the reproducing situation storage unit, a state that the reproducing operation is stopped or paused is displayed on a display unit.

10. An image reproducing apparatus comprising:
a reproducing unit for reproducing information recorded in a recording medium;
an image pickup unit for picking up an image of a viewer;
a face image detecting unit for detecting a face image from the image of the viewer picked up by the image pickup unit;
an authentication unit for authenticating a on-viewing person by comparing the face image of the viewer detected by the face image detecting unit with a face image of a previously-registered person;
a reproducing control unit for controlling recording-medium reproducing operation of the reproducing unit;
a moving object determination unit for determining whether or not there is a moving object from the picked-up image of the viewer picked up by the image pickup unit; and
a reproducing situation storage unit for storing reproducing situations of a single one viewer or a plurality of viewers, wherein
under the control of the reproducing control unit, during the recording-medium reproducing operation, if the moving object determination unit determines that there is the moving object and if it is determined that the face image cannot be detected by the face image detecting unit, the reproducing situation data including previously detected face image information, reproducing position information at the time that the face image cannot be detected, and recording-medium identifying information of the on-reproducing recording medium are stored in the reproducing situation storage unit; and if the face image is detected by the face image detecting unit, and as a result of the authentication of the authentication unit, if the person is the same as a person of the face image information stored in the reproducing situation storage unit, the reproducing operation starts at the reproducing position stored corresponding to the face image information or at a slightly pervious position thereof.

11. The image reproducing apparatus according to claim 10, wherein
under the control of the control unit, during the recording-medium reproducing operation, if the face image cannot be detected by the face image detecting unit in a predetermined time or more, the reproducing operation is stopped or paused at the time thereof.

12. The image reproducing apparatus according to claim 10, wherein
under the control of the control unit, if the time that the face image cannot be detected by the face image detecting unit is within a predetermined time or less, the reproducing operation is not stopped or paused but continuously performed.

13. An image reproducing apparatus comprising:
a reproducing unit for reproducing information recorded in a recording medium;
an image pickup unit for picking up an image of a viewer;
a face image detecting unit for detecting a face image from the image of the viewer picked up by the image pickup unit;
an authentication unit for authenticating a on-viewing person by comparing the face image of the viewer detected by the face image detecting unit with a face image of a previously-registered person; and
a reproducing control unit for controlling recording-medium reproducing operation of the reproducing unit;
an eye opened/closed state determination unit for determining opened and closed states of eyes from the face image detected by the face image detecting unit; and
a reproducing situation storage unit for storing reproducing situations of a single one viewer or a plurality of viewers, wherein
under the control of the reproducing control unit, during the recording-medium reproducing operation, if the eye opened/closed state determination unit determines that the eyes are closed in a predetermined time or more, the reproducing situation data including previously detected face image information, reproducing position information at the time of the eyes closed, and recording-medium identifying information of the on-reproducing recording medium are stored in the reproducing situation storage unit; and if the eye opened/closed state determination unit determines that the eyes are opened again and, as a result of the determination, if the person is the same as a person of the face image information stored in the reproducing situation storage unit, the reproducing operation starts at the reproducing position stored corresponding to the face image information or at a slightly pervious position thereof.

14. The image reproducing apparatus according to claim 13, wherein
under the control of the control unit, if the eyes are determined to be closed by the eye opened/closed state determination unit in a predetermined time or more, the reproducing operation is stopped or paused at the time thereof.

15. The image reproducing apparatus according to claim 13, wherein
under the control of the control unit, if the eyes are determined to be closed by the eye opened/closed state determination unit with a predetermined time or less, the reproducing operation is not stopped or paused but continuously performed.

16. The image reproducing apparatus according to any one of claims 6, 10, and 13, wherein
under the control of the control unit, when the apparatus is powered on, the on-viewing person is authenticated by the authentication unit, and if the data of the person authenticated by the authentication unit are in the reproducing situation storage unit, the reproducing situation data of the viewer are displayed on the display unit to notify the presence of the data to the viewer

17. The image reproducing apparatus according to any one of claims 2, 3, 6, 10, and 13, wherein
after the viewing is ended, the reproducing situation data stored in the reproducing situation storage unit is automatically erased.

18. The image reproducing apparatus according to any one of claims 2, 3, 6, 10, and 13, wherein
the viewer or a manager having a management authority is allowed to arbitrarily erase the reproducing situation data stored in the reproducing situation storage unit.
